(19) United States
(12) Patent Application Publication
(10) Pub. No.: US 2010/0296682 A1
(43) Pub. Date: Nov. 25, 2010

(54) Aural device

(76) Inventor: Mark Andrew Palmer, North Lincolnshire (GB)

Correspondence Address: FAY SHARPE LLP, 1228 Euclid Avenue, 5th Floor, The Halle Building, Cleveland, OH, 44115, US

(21) Appl. No.: 12/668,964

(22) PCT Filed: Jul. 11, 2008
(86) PCT No.: PCT/GB2008/050561

§ 371 Date: Jun. 11, 2010

(30) Foreign Application Priority Data
Jul. 13, 2007 (GB) 0713631.0

(51) Int. Cl. H04R 1/02

(52) U.S. Cl. 381/332

(57) ABSTRACT

A headset for use on an aircraft has a pair of earpieces (12A, 12B) on a resilient headband (22) which can hold resilient annular seals (16A, 16B) in contact with the wearer's head to give a firm seal. A drive motor (38) provides slightly pressurised air to inner chambers (18A, 18B) of the earpieces (12) via a non-kink tube (26) and the headband (22) which is hollow, the supply of pressurised air being arranged so that the change of pressure within the inner chambers (18) occurs at a slower rate than in the aircraft cabin. The rate of change can be controlled manually by a rotary control knob (34). A slider switch (32) allows the user to select pressurised air in accordance with take-off or landing of the aircraft. The headset may also have loudspeakers and microphones within the earpieces.

This invention relates to an aural device, more particularly to an aural device to assist the equalisation of pressure in the ear during rapid changes of ambient pressure, such as ascent or descent in an aircraft.

In the human ear, the visible “ear” external to the head is connected by an outer ear/auditory canal to the ear drum, which seals the canal; on the other side of the ear drum is the Eustachian tube which connects to the nose/throat. The ear drum in its rest position is planar. Any difference in pressure in the outer ear/auditory canal and the Eustachian tube causes the ear drum to bow either inwardly or outwardly, which can cause ear pain known as otic barotrauma.

It is well known that when an aircraft takes off or lands, the respective decrease and increase of air pressure in the aircraft cabin, even when pressurised, occurs at a faster rate than can be accommodated by the Eustachian tube. The result for many people is ear pain.

### BACKGROUND ART

For some people sucking sweets, swallowing, or facial manoeuvring may bring relief, but babies and young children do not understand how to use these techniques and often become distressed. Further, for people suffering from head colds and blocked sinuses, the problem is compounded.

One type of remedy is to use a decongestant spray to open up the airways of the Eustachian tube to allow pressure to be released and equalised more freely. This may give some relief but may not be effective for everyone.

There is a device consisting of a handheld unit which is placed up one side of the nostril and which gives a constant stream of air into the nasal canal. When the person swallows, this air is diverted up into the Eustachian tube and clears the middle ear. The device is however rather obtrusive.

There are also ear plugs that many people use to help slow the rate of change of pressure that is put upon the ear drums. They consist of two elements: a hypoallergenic silicone ear plug and a ceramic pressure regulator. The silicone earplug has four circumferential rings which provide an airtight seal between the product and the ear canal. The ceramic element is a controlled porosity filter, one end of which is exposed to the external cabin pressure, with the opposite end exposed to the sealed chamber formed when the ear plug is inserted in the ear. Thus, as the cabin pressure changes, a pressure differential is created across the ceramic filter, thereby causing air to flow through the filter. The filter acts as an impedance to the flow of air into and out of the ear canal. Such a device may be effective remedy but is less effective for small children and for adults with blocked sinuses.

It is an object of the invention to provide an aural device which overcomes the disadvantages of the prior art.

### DISCLOSURE OF THE INVENTION

According to the invention, an aural device comprises a pair of earpieces sealingly engageable with the ears of a wearer to provide a firm seal; and means for supplying gas to the earpieces so that the pressure in the auditory canals/outer ears of the wearer is different from the ambient pressure.

The aforesaid firm seal is sufficient for the air pressure difference inside and outside the earpieces to be maintainable without causing discomfort to the wearer; it need not be a fully airtight seal. The gas may be provided from a gas bottle; the gas may be air and may be supplied by a pump.

Preferably the means for controlling the gas pressure is arranged to change the gas pressure within the earpieces at a slower rate than any changes to gas pressure outside the earpieces.

Preferably the means for controlling the air pressure comprises manual selection means to allow the user to select said slower rate of change.

Optionally the aural device further comprises microphone and/or loudspeaker means within at least one earpiece.

The invention will now be described by way of example only with reference to the accompanying drawings in which:—

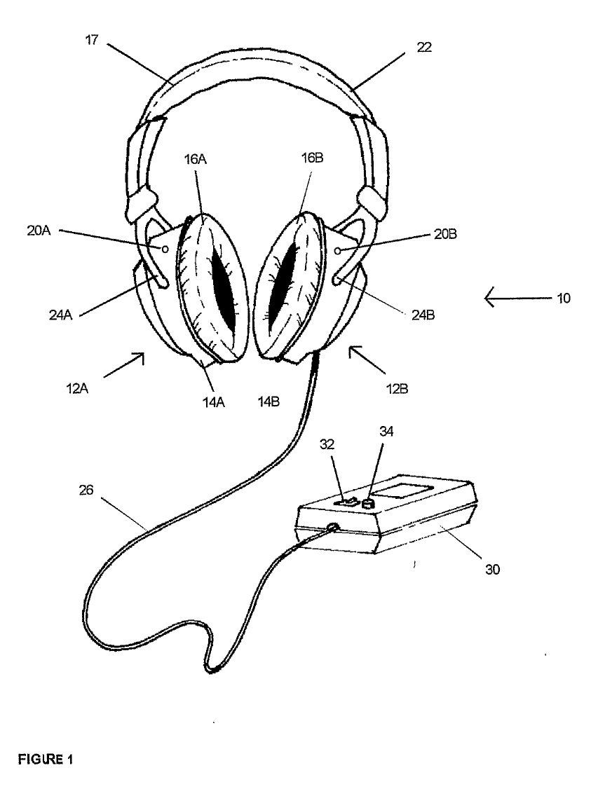

FIG. 1 is a view of an aural device according to the invention;

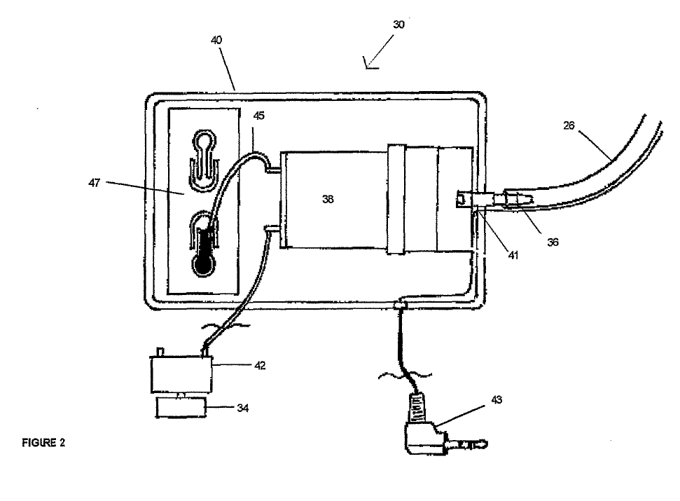

FIG. 2 is detail view in part section of the controller of the FIG. 1 device; and

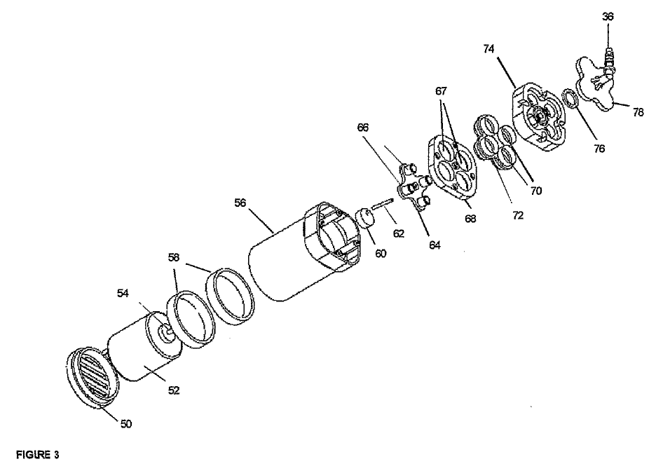

FIG. 3 is an exploded view of an air pump within the controller of the FIG. 2 device.

In FIG. 1, an aural device 10 comprises a pair of earpieces 12A, 12B each comprising a rigid outer casing 14A, 14B and a resilient toroidal seal 16A, 16B having central apertures of sufficient dimension to encompass the human ear.

Within the casings are inner chambers 18A, 18B (not shown). In the rigid casing 14 there are pressure release valves 20A, 20B between the inner chambers and the ambient air.

A resilient headband 22 intended to go over the top of the wearer's head is connected to the outer rigid casings 14 by U-shaped pivots 24A, 24B which allow the resilient seals 16 to take up the correct angle to seal around the wearer's ears. The resilient headband 22 provides sufficient pressure on the resilient seals 16 to provide firm seals around the wearer's ears, but a completely airtight seal is not necessary, as will be explained later. The U-shaped pivots 24 are slidable up or down the headband 22, as is conventional, to adjust the length of the headband which provides a comfortable fit on the head and also some adjustment to the firmness of the seal.

The resilient headband 22, shown partly cut-away, and the U-shaped pivots 24 are hollow, thus providing a continuous, essentially tubular, connection between inner chamber 18A and inner chamber 18B in the earpieces 12A and 12B respectively. A non-kink tube 26 is connected to the outer casing 14B and to a control device 30 having a two-position slider switch 32 and a rotary control 34.

FIG. 2 shows the controller 30 connected to the non-kink tube 26 by a push-fit nozzle 36 attached to a pump 38. Within the housing 40 of the controller 30 is a housing 47 for a battery power supply electrically connected to the pump 38 by wire 45. The Figure also shows a potentiometer 42 which with the rotary knob constitutes the rotary control 34.

The pump 38 is shown in exploded form in FIG. 3. At the end remote from the push-fit nozzle 36 is a perforated intake cover 50 and a 9-volt piston drive motor 52 having a spindle 54. The drive motor 52 is sealed within a motor cover 56 by two annular sponges 58. Beyond the cover 50 is a crank 60 on a shaft 62 which cooperates with a driving body 64 having four axially-operating pistons 66 shown at different parts of their operating cycles. Each piston reciprocates within one of four circular apertures 67 in a middle cover 68 so as to operate on one of four diaphragms 70 held in a diaphragm member 72. The diaphragm member 72 is sealed in a top cover 74 which carries an “O” ring 76 which seals against the inner surface of an outlet cover 78 carrying the push-fit nozzle 36.

In operation, an air traveller dons the aural device while the aircraft is on the ground where, at sea level, the ambient air pressure is about 14.7 pounds per square inch or 760 millibars of mercury. An aircraft flying at, say, 39,000 feet conventionally has a cabin air pressure equivalent to 7000 feet of altitude, ie about 11.3 pounds per square inch or 586 millibars. The conventional rate of climb of the aircraft is such that the subsequent decrease in pressure is faster than can be accommodated by the human ear.

On take-off the wearer selects the setting on the rotary switch 34 corresponding to take-off, ie a decrease in cabin pressure, selecting an appropriate setting which will be explained later. The slider switch 32 is set, as it normally is, to the “supply air” position. The piston drive motor 52 operates the four pistons 66 to pump air drawn through the intake cover 50 through the push-fit nozzle 36 and non-kink tube 26 into the inner chamber 18B of earpiece 12B, through the hollow U-shaped pivot 24B and hollow headband 22 into the inner chamber 18A of earpiece 12A.

The supplied air is largely retained within the earpieces 12 because the resilient seals 16 are pressed against the wearer's head by the resilient headband 22. Thus slightly compressed air enters the wearer's outer ear/auditory canals and acts to equalise the as yet unreleased pressure in the Eustachian tube; thus the convexity of the ear drum is at least partly, and possibly wholly, released so the ear drum is close to or at its planar rest position. Slowly the pressure in the Eustachian tube equalises to the cabin pressure, the pressure supplied by the pump keeping pace with the slow change.

The rate of supply of air is controlled so that the required increased pressure is maintained within the inner chambers 18 even though some air will leak through the imperfect seal of the earpieces 12 around the wearer's head.

The result is that many people experience a reduction in discomfort.

When pressures are fully equalised the wearer may chose to remove the aural device.

When the aircraft begins to descend, the aural device is replaced, the wearer selects a position on the rotary switch corresponding to increase in cabin pressure, and air is supplied so that the increase in pressure on the eardrum is equalised at a slower rate than would occur by direct exposure of the ears to the cabin pressure.

Reference has been made to selection of a setting on the manual control knob 34. The wearer may change the setting during ascent or descent if the increase or decrease in pressure supplied by the aural device is felt to be insufficient to avoid discomfort. A frequent flier may have sufficient experience to know the most comfortable personal setting in advance, from previous flights. Naturally the settings on the rotary knob 34 are clearly marked (not shown) and the range of possible settings on the rotary knob 34 is chosen so that dangerously high or low pressure change rates cannot be selected. Further, the pressure release valves 20 will operate to release pressure if a preset pressure difference between cabin and one or both earpieces is sensed, in the unlikely event of a blockage of the non-kink tube 26.

If one or both earpieces 24 is removed by accident by a child, or to scratch an ear, a comfortable pressure within the earpieces may be quickly restored by use of the slider switch 32 to reverse the polarity of the piston motor so that a vacuum is supplied and pressure reduces; a second use of the slider switch 32 then restarts the pressure equalisation process.

In variations, not illustrated, the resilient seals 16 may be of a disposable nature. The manual control 34, shown as a rotary knob, may alternatively be a push button or touch screen control with preset rates of pressure equalisation. Instead of battery operation, mains power may be supplied. The slider switch 32 may be in the form of a directional switch, or push button switch, or a rocker switch. The electrical parts may be compatible with requirements for use on an aircraft.

As an alternative to use of a pump, a slow release gas canister can be provided to supply air to the aural device. Instead of supplying earpiece 12A through the headband 22, there may be a direct connection through a Y-shaped connection to non-kink tube 26 to both earpieces 12, although the additional tubing may render the aural device less convenient to use. The pump 38 may be a miniaturised pump contained within one or both of the earpieces 12, which may also carry the battery and switches; in this variation the non-kink tube 26 will not be required. Automatic setting of the switches 32 and 34 may also be provided.

The aural device 10 may be made foldable for neat storage in a carrying case (not shown).

In further variations (not illustrated), instead of the external earpieces 12, the aural device 10 may be provided with a pair of internal or in-ear ear pieces, which will be inserted into the outer part of the outer ear/auditory canal to provide a firm seal.

While some users may chose to remove the aural device once ear pressure has equalised to cabin pressure, the device may have additional features which allow the device to remain advantageously in place.

Referring again to FIG. 1, each earpiece 12 is supplied with a small loudspeaker, the housings being shown at 15A, 15B: an electrical connection wire 17 passes through the hollow headband (as shown in the cutaway) and through the hollow pivots 24 to each microphone, then through the non-kink tube 26 to the control device 30, as seen in FIG. 2. The wire 17 then passes through an aperture 41 in the housing 40 to connect to a standard audio jack 43.

By connection of the jack 43 to an appropriate source, the loudspeakers can supply the aircraft entertainment audio signal, or in-flight announcements, or may be connected to a personal audio source such as an MP3 player or iPod or games console or the like. The loudspeaker housings may additionally be supplied with microphones to act as hearing aids. The loudspeakers and microphones can operate during the pressure equalisation process or at other times.

If the jack 43 is not connected to an audio source, retention of the aural device on the head will allow the resilient seals 26 to act as sound dampers to ambient noise, allowing the wearer to enjoy a quieter flight, and to work or sleep more comfortably.

1. An aural device comprising:
a pair of earpieces sealingly engageable with the ears of a wearer to provide a firm seal;
means for supplying gas to the earpieces; and
control means arranged so that the pressure in the outer ear/auditory canals of the wearer changes at a different rate to any change in the ambient pressure.

2. An aural device according to claim 1 further comprising:
means for supplying vacuum to the earpieces; and
manual switch means arranged so that the wearer can select the supply of gas or of vacuum.

3. An aural device according to claim 1 in which the control means comprises manual selection means to allow the wearer to control said different rate of pressure change.

4. An aural device according to claim 3 in which the manual selection means is provided with a plurality of automatic settings.

5. An aural device according to claim 1 further comprising pressure release means arranged to operate at a preset pressure difference between ambient pressure and one or both earpieces.

6. An aural device according to claim 1 in which the earpieces cover the wearer's ears, and further comprises resilient support means to support the earpieces in contact with the wearer's head.

7. An aural device according to claim 1 in which the earpieces are arranged within the wearer's outer ears/auditory canals to provide firm seals.

8. An aural device according to claim 1 in which at least one earpiece is provided with a loudspeaker.

9. An aural device according to claim 8 in which the at least one loudspeaker is connectable to an aircraft entertainment system or to an in-flight announcement system or to a personal audio source.

10. An aural device according to claim 2 in which the control means comprises manual selection means to allow the wearer to control said different rate of pressure change.

11. An aural device according to claim 2 further comprising pressure release means arranged to operate at a preset pressure difference between ambient pressure and one or both earpieces.

12. An aural device according to claim 3 further comprising pressure release means arranged to operate at a preset pressure difference between ambient pressure and one or both earpieces.

13. An aural device according to claim 4 further comprising pressure release means arranged to operate at a preset pressure difference between ambient pressure and one or both earpieces.

14. An aural device according to claim 2 in which the earpieces cover the wearer's ears, and further comprises resilient support means to support the earpieces in contact with the wearer's head.

15. An aural device according to claim 3 in which the earpieces cover the wearer's ears, and further comprises resilient support means to support the earpieces in contact with the wearer's head.

16. An aural device according to claim 4 in which the earpieces cover the wearer's ears, and further comprises resilient support means to support the earpieces in contact with the wearer's head.

17. An aural device according to claim 5 in which the earpieces cover the wearer's ears, and further comprises resilient support means to support the earpieces in contact with the wearer's head.

18. An aural device according to claim 2 in which the earpieces are arranged within the wearer's outer ears/auditory canals to provide firm seals.

19. An aural device according to claim 3 in which the earpieces are arranged within the wearer's outer ears/auditory canals to provide firm seals.

20. An aural device according to claim 4 in which the earpieces are arranged within the wearer's outer ears/auditory canals to provide firm seals.
